(19) United States
(12) Patent Application Publication
(10) Pub. No.: US 2021/0241266 A1
(43) Pub. Date: Aug. 5, 2021

(54) ENHANCING 3D SECURE USER AUTHENTICATION FOR ONLINE TRANSACTIONS

(71) Applicant: Mastercard International Incorporated, Purchase, NY (US)

(72) Inventors: Ashfaq Kamal, Stamford, CT (US); Rahul Deshpande, Chesterfield, MO (US); Manash Bhattacharjee, Jersey City, NJ (US)

(21) Appl. No.: 17/162,604

(22) Filed: Jan. 29, 2021

Related U.S. Application Data
(60) Provisional application No. 62/968,380, filed on Jan. 31, 2020.

(51) Int. Cl. G06Q 20/38; H04L 29/06

(52) U.S. Cl. CPC G06Q 20/3821; G06Q 20/3829; H04L 63/0892; H04L 63/0861

(57) ABSTRACT

An enhanced 3D Secure user authentication process and system. In some embodiments, a consumer device processor of a consumer device running a Web Authentication application programming interface (API) transmits a request to a relying party device requesting use of an enhanced 3D Secure authentication service. The consumer device processor then receives a request to authenticate a consumer from the relying party device by using a specific customer verification method (CVM), prompts, by running the Web Authentication API, the consumer to provide input in accordance with the CVM, receives input data in accordance with the CVM from an authenticator of the consumer device, verifies the consumer based on the input data, generates an authentication data package and transmits to the relying party device the authentication data package for processing and forwarding to a 3D Requestor environment.

### CROSS REFERENCE TO RELATED APPLICATION

This application claims the benefit of U.S. Provisional Patent Application No. 62/968,380 filed on Jan. 31, 2020, the contents of which provisional application are hereby incorporated by reference for all purposes.

### FIELD OF THE INVENTION

Embodiments of the invention generally relate to user authentication techniques. More specifically, embodiments relate to enhancing the 3D Secure 2.0 protocol to include additional data points and/or analytics related to user authentication which occurred during Card-Not-Present (CNP) or online transactions.

### BACKGROUND OF THE INVENTION

More and more transactions involve a user operating a mobile device. A common example of such a transaction is a payment transaction, although a large number of other types of transactions will benefit from the improved authentication techniques described herein. For convenience, payment transactions will be described, however, those skilled in the art, upon reading this disclosure, will appreciate that other types of transactions may be beneficially used with the authentication techniques described herein.

Payment card-based transactions are now typically performed across multiple channels of commerce. For example, payment card-based transactions may be performed in-person at a retail outlet, via a computer connected to the Internet (an online transaction) or other network, via a mobile device such as a smartphone, and/or via a company-based call center (e.g., via a 1-800 number for a catalog company). These various types of transactions are conducted in different ways, and thus each type of transaction is associated with a different level of trust and/or fraud risk. In addition, payment card transactions generally require that the consumer have his or her payment card available to either present to a cashier in a retail environment, or to enter requested information (such as a sixteen-digit payment card account number, an expiration date, and a credit card verification value (CVV) number, which typically is printed on a back side of the payment card) via a web browser for an online or Internet transaction, and/or to provide requested information over the telephone.

Persons skilled in the art recognize that the risk of fraud is greater for a remote transaction (such as an online or Internet purchase or payment transaction) because there is less ability for a merchant or payee to verify the identity and/or authenticity of the payer or cardholder. The nature of remote or Internet or online transactions (sometimes referred to as “Card-Not-Present” (CNP) transactions) therefore increases risk for merchants and for payment card network providers. This increased risk often results in more cardholder disputes and associated chargebacks than occur after in-person purchase or payment transactions and can also result in lower transaction approval rates.

With the advent of e-commerce and m-commerce (mobile commerce), consumers are increasingly using personal computers and/or payment-enabled portable or mobile devices (such as smart phones, tablet computers, personal digital assistants (PDAs), laptops, and/or digital music players) to make CNP purchases via merchant websites over the Internet. Thus, various techniques have evolved in an attempt to prevent or minimize fraud and that allow for secure payment for goods and/or services ordered online by consumers or cardholders using their payment card accounts. For example, the three-domain secure (3D Secure 1.0) protocol is a messaging protocol designed to provide an additional security layer for online payment card transactions, and it ties the financial authorization process with online authentication based on a three-domain model. The three domains are the acquirer domain (which includes the merchant and the merchant's bank to which money is being paid), the issuer domain (which typically includes the bank that issued the cardholder's or consumer's payment card account), and the interoperability domain (which includes the network infrastructure provided by the payment card scheme or payment services provider, such as a directory service server computer(s) and/or payment network server computer(s), which supports the 3-D Secure protocol). The 3D Secure protocol was designed to secure the merchant, the card issuer and the financial transaction, and was adopted by payment processing companies such as Mastercard International Incorporated, VISA®, JCB International Co., Ltd., and American Express® into their own branded services.

When a merchant uses the 3D Secure 1.0 service, the burden of fraud responsibility shifts onto the card issuer, which reduces chargebacks for the merchant. However, some cardholders balked at using the 3D Secure 1.0 protocol because it required creation of difficult to remember passwords that had to be entered into a suspicious-looking pop-up window (a challenge message) during a purchase transaction, which savvy Internet users typically avoid doing as a matter of safe browsing habits (to avoid identity theft). Thus, the 3D Secure 1.0 protocol caused friction for online consumers because the consumer not only had to remember the passwords associated with his or her payment cards but also had to enter one when requested, which added an extra step during purchase transactions. Thus, consumers shied away from using it. In addition, 3D Secure 1.0 only supported browser-based transactions. Cardholders therefore either begrudgingly set up the required 3D Secure 1.0 passwords or abandoned the purchase transaction (declined to checkout). Merchants are very concerned about shopping cart abandonment, and thus when it was reported that, in some countries purchase transaction conversion rates on merchant websites that used 3D Secure 1.0 decreased somewhat dramatically (from more than fifty percent to about ten percent), many merchants decided against using the 3D Secure 1.0 service. Those merchants therefore decided that the loss in conversion rates (due to shopping cart abandonment) was too great a price to pay in exchange for slightly less fraud occurrences. Moreover, some security experts argued that the system is still vulnerable because it was next to impossible for users to distinguish a legitimate 3D Secure 1.0 pop-up from a phishing scam.

More recently, the 3D Secure version 2.0 protocol replaced the use of a pop-up window and passwords with an “invisible authentication” process that does not require use of static passwords. Instead, 3D Secure 2.0 makes use of biometric user authentication methods, such as those that rely on fingerprints, face and/or voice recognition. Biometric authentication is currently enabled in different types of mobile devices, for example, several versions of the Apple iPhone® and some Android® smartphones utilize facial recognition and/or fingerprint recognition to authenticate a user and then unlock the cell phone for use, and thus consumers are familiar with such processes. In addition, the 3D Secure 2.0 messaging protocol also enables creating a framework for digital authentication that makes its use possible on a wider set of devices, and thus 3D Secure 2.0 payments are possible for both application and browser-based solutions.

The 3-D Secure 2.0 protocol also uses more contextual data than 3-D Secure 1.0, which results in speeding up purchases for low-risk transactions, offering greater security for high-risk transactions, and decreased shopping cart abandonment. For example, new contextual data used by 3-D Secure 2.0 includes device information, service information, gift card information, time zone data and screen height. Thus, based on the contextual data, for low-risk transactions, an issuer can choose to verify the identity of the cardholder without imposing an authentication step, and thus customers will spend up to eighty-five percent (85%) less time in the checkout process (which is important because a large majority of purchase transactions are considered to be low-risk transactions by issuers). For 3D Secure 2.0 transactions considered by issuers to be of higher-risk, then the issuer may choose to perform an authentication step, and the contextual data helps the issuer to better understand the background of the high-risk transaction. For example, the contextual data may indicate the type of device the cardholder uses for transactions, a purchasing pattern of the cardholder, and what hours the cardholder usually performs transactions, which can be compared to the data gathered for the current transaction and then used to decide whether or not to authenticate the user. Moreover, in some circumstances, even for a higher-risk transaction, the cardholder contextual data may make a user authentication step unnecessary, resulting in a further decrease in cart abandonment.

Even though the 3D Secure 2.0 protocol is an improvement over prior messaging protocols, there are currently no standard elements and/or other relevant data to capture which indicates that a user performed strong device-based authentication or universal two-factor authentication (U2FA). As a result, the chances that a user will be subjected to a stepped-up authentication process or be required to provide further user authentication information is increased. The inventor recognized that it would therefore be desirable to offer an enhanced 3D Secure 2.0 messaging service that includes a standardized format and that provides additional data points and/or analytics so that a cardholder is not subjected to stepped-up authentication processing and/or need not perform another user authentication step, resulting in an improved user experience and decreasing the likelihood of electronic shopping cart abandonment.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of a 3D Secure (3DS) messaging architecture in accordance with some embodiments of the disclosure;

FIG. 2 is a block diagram illustrating a W3C Web Authentication Application Programming Interface (API) user registration process in accordance with some embodiments of the disclosure;

FIG. 3 is a block diagram illustrating an enhanced 3D Secure user authentication process in accordance with some embodiments of the disclosure;

FIG. 4 is a table illustrating enhanced 3D Secure design with secure authentication and/or Web Authentication data elements in accordance with some embodiments of the disclosure;

FIG. 5 is a block diagram of a user or consumer mobile device to illustrate device hardware components that may be utilized to perform consumer authentication according to some embodiments of the disclosure; and

FIG. 6 is a block diagram of an access control server (ACS) computer in accordance with some embodiments of the disclosure.

### DETAILED DESCRIPTION

In general, and for the purpose of introducing concepts of novel embodiments described herein, provided are systems and methods for enhancing the 3D Secure 2.0 protocol service to include additional data points and analytics for provision to issuer financial institutions (FIs). The additional data points and analytics may be associated with prior user authentication results and the like concerning prior online purchase transactions. The issuer FIs can then utilize this additional pertinent data to make informed authorization decisions during a current online transaction. More specifically, disclosed is an enhanced 3D Secure 2.0 protocol service that can include data points and analytics indicating that the user conducted strong authentication, for example, Web Authentication, during a previous Card-Not-Present (CNP) or online transaction. Such functionality results in an improved user experience by reducing step-up authentication requests, and it also improves the accuracy of a scoring engine of the user authentication network.

A number of terms will be used herein. The use of such terms is not intended to be limiting, but rather their use is for convenience and ease of exposition. For example, as used herein, the term “user” may be used interchangeably with the term “cardholder” and/or with the term “consumer,” and these terms are used herein to refer to a person, individual, business or other entity that owns (or is authorized to use) a financial account such as a payment card account (such as a credit card account or debit card account). In addition, the term “payment card account” may include a credit card account, a debit card account, a loyalty card account, and/or a deposit account or other type of financial account that an account holder or cardholder may access or utilize for transactions. The term “payment card account number” includes a number that identifies a payment card system account, or a number carried by a payment card, and/or a number that is used to route a transaction in a payment system that handles debit card and/or credit card transactions and the like.

Moreover, as used herein the terms “payment card system” and/or “payment system” and/or “payment network” refer to a system and/or network for processing and/or handling purchase transactions and/or related transactions, which may be operated by a payment card system operator such as MasterCard International Incorporated, or a similar system. In some embodiments, the term “payment card system” may be limited to systems in which member financial institutions (such as banks) issue payment card accounts to individuals (which may be referred to as “issuer financial institutions” or “issuer FIs”), businesses and/or other entities or organizations. In addition, the terms “payment system transaction data” and/or “payment network transaction data” or “payment card transaction data” or “payment card network transaction data” refer to transaction data associated with payment transactions and/or purchase transactions that have been processed over a payment network or payment system. For example, payment system transaction data may include a number of data records associated with individual payment transactions (or purchase transactions) of consumers that have been processed over a payment card system or payment card network. In some embodiments, payment system transaction data may include information that identifies a cardholder, a cardholder's payment device or payment account, a transaction date and time, a transaction amount, merchandise or services that have been purchased, and information identifying a merchant and/or a merchant category. Additional transaction details may also be available in some embodiments.

In addition, throughout this disclosure examples of a financial transaction will be described. However, those skilled in the art will appreciate that embodiments may be used with desirable results in other types of transactions. Also, it should be understood that a consumer or user mobile device may be a connected mobile wireless device (such as a smart phone, tablet computer, personal digital assistant (PDA), laptop computer, or the like), which can be leveraged to provide additional factors and/or data for user authentication. For example, authentication technologies such as finger print biometrics, voice biometrics, user gait biometrics and others may be utilized with the architecture described herein.

Reference will now be made in detail to various novel embodiments and/or implementations, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

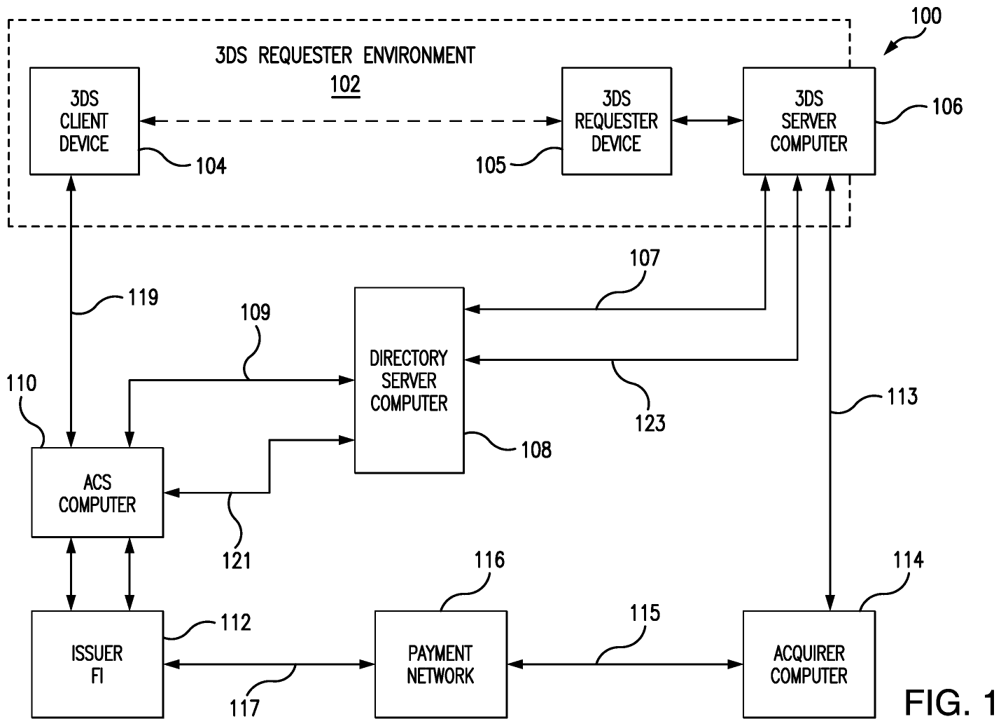

FIG. 1 is a block diagram of a 3D Secure (3DS) messaging architecture 100 in accordance with some embodiments. The 3DS requestor environment 102, which may be associated with merchants or other entities, supports 3DS Requestor application programming interfaces (APIs), 3DS Server APIs, and browser interaction communications between 3DS electronic devices such as the 3DS client device 104 (being utilized by a user or consumer), a 3DS requestor device 105, and a 3DS Server computer 106. In some embodiments, the 3DS client device 104 may be a consumer mobile device such as a smartphone that includes one or more biometric components and/or sensors for capturing user biometric data during a user authentication process, for example, that is part of the processing of an online transaction. The 3DS requestor device 105 may also be a smartphone or other type of computing device, such as a tablet computer, laptop computer and the like, operated by a requestor (such as a merchant).

In one example, during a checkout process of an online purchase transaction, the 3DS client device 104 transmits authentication data via the 3DS requestor device 105 to the 3DS Server computer 106, which then transmits 107 an authentication request to a directory server computer 108 (which may be owned and/or operated by a payment processing entity such as Mastercard International Incorporated). The authentication request may be in the form of a data package containing biometric authentication data and cardholder account information. The directory server computer 108 then utilizes the cardholder account information to determine which one of a plurality (not shown) of issuer financial institution (FI) servers 112 (only one is shown in FIG. 1 for the sake of clarity) to contact concerning the authentication request.

In the example shown in FIG. 1, the directory server computer 108 identifies the issuer FI 112 as the issuer of the cardholder's payment card account and then transmits 109 the authentication request to the access control server (AC S) computer 110 associated with the issuer FI 112 for further processing. If ACS computer 110 authenticates the user, then a positive authentication response is transmitted 109 to the directory server computer 108, which then transmits 107 that authentication response back to the 3DS server computer 106 for further processing. The 3DS server computer 106 next transmits 113 a payment request to the merchant's acquirer FI 114. In this case, the merchant's acquirer FI 114 then transmits an authorization message 115 to the payment network 116, which identifies the cardholder's issuer FI 112 and transmits an authorization message to the issuer FI 112 for purchase transaction authorization. If all is in order, meaning that the cardholder's account at the issuer FI 112 includes adequate funding and/or an adequate credit line, then the issuer FI 112 authorizes the transaction and transmits 117 a positive authorization response with payment data to the payment network 116 for forwarding 115 to the acquirer FI 114.

However, if the ACS computer 110 does not authenticate the user after receiving the authentication request 109, then the 3DS server computer 106 receives a negative authentication response 107 from the directory server computer 108. In this case the payment transaction may be declined, but in some cases may still be forwarded to the acquirer FI computer 114 for further processing. For example, in some implementations, the 3DS server computer 106 may determine that the purchase transaction is a low value transaction (or low risk transaction) of a type that the cardholder is known to have entered into in the past, and thus there is a low risk of fraud. In such a situation, processing would continue as described above with the 3DS Server computer 106 transmitting 113 a payment request to the merchant's acquirer FI computer 114 for payment transaction authorization processing, as described above (involving the acquirer computer 114, payment network 116 and issuer FI 112).

Referring again to FIG. 1, in cases involving a high-value or a high-risk transaction, when the ACS computer 110 receives 109 the authentication request from the directory server computer 108, the ACS computer 110 may determine (sometimes based on business rules or predetermined policy criteria) that more information or additional user data is required before an authentication response can be generated. In such cases, processing may include the ACS computer 110 generating a challenge message and transmitting 119 the challenge message to the 3DS client device 104. Such a challenge message may request entry of a mobile device password or the like from the user of the 3DS client device 104.

Thus, the standard 3DS version 2.0 messaging process requires the cardholder to respond to a challenge message (step-up authentication) only when required to do so, for example, if the fraud risk is high, or if there are regional requirements mandating such a step-up process. In such situations, the user or consumer of the 3DS client device 104 provides the necessary data (such as a password) and a challenge response 119 is transmitted to the ACS Server computer 110. The ACS server computer 110 then determines, based on the data provided by the user in the challenge response, whether or not to send a positive authentication response 109 to the directory server computer 108 along with a results response message 121. In some implementations, the results response message 121 includes the details of the completed challenge message and a proof of authentication. In this situation, the directory server computer 108 transmits 107 the authentication response and transmits 123 the results response message to the 3DS server computer 106. The 3DS server computer then generates a payment request to transmit 113 to the merchant acquirer 114, and then processing continues as explained above for the transaction authorization processing. As will be explained in detail below, processes disclosed herein beneficially provide and/or include additional information and/or data so that for some transactions the ACS computer 110 can authenticate the cardholder without transmitting a challenge message 119 to the 3DS client device 104. In such cases, the user would then not be required to provide a response to a challenge message for the online transaction to move forward, which improves the cardholder purchase experience by reducing friction in the overall transaction network. Such processing may also result in a reduction in the likelihood of user abandonment of an electronic shopping cart during processing of an online purchase transaction.

The World Wide Web Consortium (W3C) is an international community where member organizations, a full-time staff, and the public work together to develop Web standards. One of those standards is the W3C Web Authentication specification, which defines a Web Authentication API that enables the creation and use of strong, attested, scoped, public key-based credentials by web applications, for the purpose of strongly authenticating users. A public key credential is first created and stored by an authenticator (which authenticator may be associated with a hardware component of a consumer's mobile device, for example, with a fingerprint sensor) at the behest of a Relying Party (such as a merchant), subject to user consent. Subsequently, the public key credential can only be accessed by origins belonging to that Relying Party. This scoping is enforced jointly by conforming User Agents and authenticators, and privacy across Relying Parties is maintained. In particular, a first Relying Party is not able to detect any properties, or even the existence, of credentials scoped to a second Relying Party (or to any other Relying Parties).

Relying Parties, such as merchants, employ the Web Authentication API during two distinct, but related, activities involving a user or consumer. The first activity is user registration, where a public key credential is created on an authenticator of the user's mobile device, and then associated with the user's account (the user's account may already exist or may be created at this time) by the Relying Party. The second activity is authentication, where the Relying Party is presented with an “Authentication Assertion” proving the presence and consent of the user who registered the public key credential. For example, in some implementations an Authentication Assertion may include a cardholder's signature plus additional meta-data associated with cardholder. Functionally, the Web Authentication API includes a Public Key-Credential which extends the Credential Management API (CREDENTIAL-MANAGEMENT-1), and infrastructure which allows those credentials to be used with “make.credential” and “get.assertion” instructions. The former is used during a Registration process, and the latter is used during the Authentication process. In embodiments disclosed herein, the disclosed process captures or obtains the strong authentication data captured during the device level attestation and subsequent assertion process, and uses that strong authentication data to enhance the 3DS authentication message.

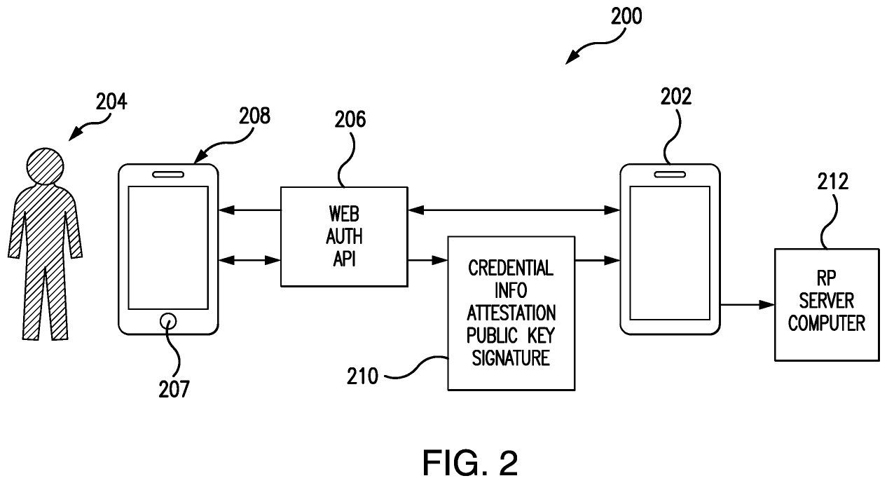

FIG. 2 is a block diagram 200 illustrating a W3C Web Authentication Application Programming Interface (API) user registration process in accordance with some embodiments. A Relying Party 202, such as a merchant, may offer consumers 204 the opportunity to participate in an enhanced 3D Secure service in accordance with some embodiments. For example, a particular cardholder or consumer 202 may be provided with an offer on a merchant's web page to participate in an enhanced 3D Secure service. After the cardholder accepts the offer to participate in the 3D Secure authentication service, the cardholder's or consumer's mobile device 208 downloads a Web Authentication API 206 via a web browser, for example. The Web Authentication API 206 is then utilized to facilitate registration for the enhanced 3D Secure service. In particular, after it is loaded, the Web Authentication API 206 generates a credentials request (for example, a “make.credential” request). In some embodiments, the consumer 202 responds to the make.credential request by utilizing an authenticator component 207 of the mobile device 208 to provide biometric data (such as fingerprint data, iris scan data, facial data, and the like). In some implementations, the authentication components of the consumer's mobile device 208 may be configured to utilize a user authentication standard such as the “FIDO” standards promulgated by the Fast Identity Online Alliance (available at www.fidoalliance.org, and incorporated herein by reference in their entirety for all purposes). However, other user authentication standards or implementations may also be used with desirable results. Thus, in some implementations, the biometric data provided by the consumer during the registration process is processed by a mobile device processor of the mobile device 208 to verify that the user is authentic.

Referring again to FIG. 2, after user verification, the Web Authentication API 206 creates a user private key (which is retained by the authenticator of the consumer's mobile device) and creates a user public key, which are transmitted back to the Relying Party 202. The Web Authentication API 206 also generates credential information and attestation data and creates a credential data package 210 that includes the credential information, the attestation data, and the user's public key. The private key for authentication is thus created and stored on an authenticator 207 in conjunction with the Web Authentication API 206, and a user agent mediates access to the public key credentials in order to preserve user privacy. In implementations, the authenticators are responsible for ensuring that no operation is performed without user or consumer consent. An authenticator provides cryptographic proof of its properties to a Relying Party 202 via attestation. Thus, after the credentials data package 210 is created, the Web Authentication API 206 signs the credentials data package and transmits it back the Relying Party 202. The Relying Party 202 then registers the consumer and in some implementations stores the public key in a database of a Replying Server computer 212 for consumer or user biometric authentication (typically by using the FIDO protocol). Thus, the credential data package 210 can be utilized by the Relying Party 202 during future purchase transactions to authenticate the user.

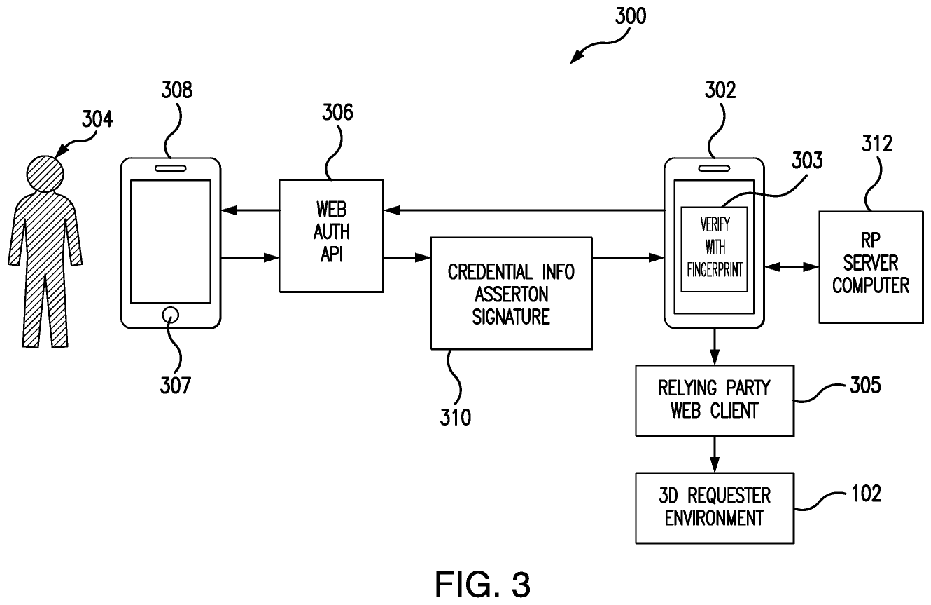

FIG. 3 is a block diagram for illustrating an enhanced 3D Secure user authentication process 300 in accordance with some embodiments. The consumer or user 304 shops on a merchant's website (the “Relying Party”) using a browser on a consumer mobile device 308, finds items to purchase, and then enters a checkout process (not shown) which includes providing payment by using a payment card account of the consumer. After the consumer 304 registers to utilize the enhanced 3D Secure service user authentication service (as explained above with regard to FIG. 2), he or she may transmit a request during a checkout process (not shown) from the Relying Party's online store, to use the enhanced 3D Secure authentication service.

Referring again to FIG. 3, the Relying Party may be utilizing a Relying Party device 302 (or merchant device 302, such as a smartphone) and in response to the received request to use the enhanced 3D Secure authentication service may transmit an authentication request to the consumer mobile device 308. In some embodiments, the authentication request specifies a particular type of consumer verification (CVM) process for the consumer to follow (for example, the CVM process may require the consumer to utilize a fingerprint or a voice print authentication process), wherein the specific type of CVM process may depend upon the type of authentication components (such as a fingerprint sensor and/or voiceprint sensor) available on the consumer mobile device 308. For example, the consumer may transmit a request to use a “verify with fingerprint” option 303 to the merchant's website, and the Web Authentication API 306 (which was downloaded during registration to the user's mobile device 308) would then present a “getAssertion” request to the Authenticator 307 (which may be a fingerprint sensor) of the user's mobile device 308 to prompt the consumer to provide biometric input data via the Authenticator to verify the consumer (using the particular CVM specified by the Relying Party 302). The consumer then utilizes the Authenticator 307 to provide his or her fingerprint for verification. After the consumer is verified, the Web Authentication API 306 next generates an authentication data package 310. In some embodiments, a consumer device processor of the consumer mobile device 308 generates the authentication data package 310 by assembling credential information data and assertion data, and then signs the authentication data package 310. The signed authentication data package is then transmitted by the consumer device processor via the Web Authentication API 306 to the Relying Party device 302.

Referring again to FIG. 1, the Relying Party device 302 receives the signed authentication package and then utilizes the user's public key (which was stored in a memory or database during the consumer registration process) to verify the signature from the consumer's device, and then discovers the user identification data in the Relying Party (RP) server computer 312. In addition, the Relying Party device 302 transmits via a Relying Party Web client 305 the consumer's credential information data and assertion data to the 3DS Server 106 (See FIG. 1) found in the 3DS Requestor environment 102, so that the consumer's credential information data and assertion data can be stored for future use when that consumer initiates a purchase transaction in the future. Thus, the consumer's credential information data and assertion data can be compared to and/or contrasted with data from a current and/or future purchase transaction in order to determine whether the consumer can be authenticated without providing a challenge request for certain types of transactions (for example, for low value and/or medium value transactions).

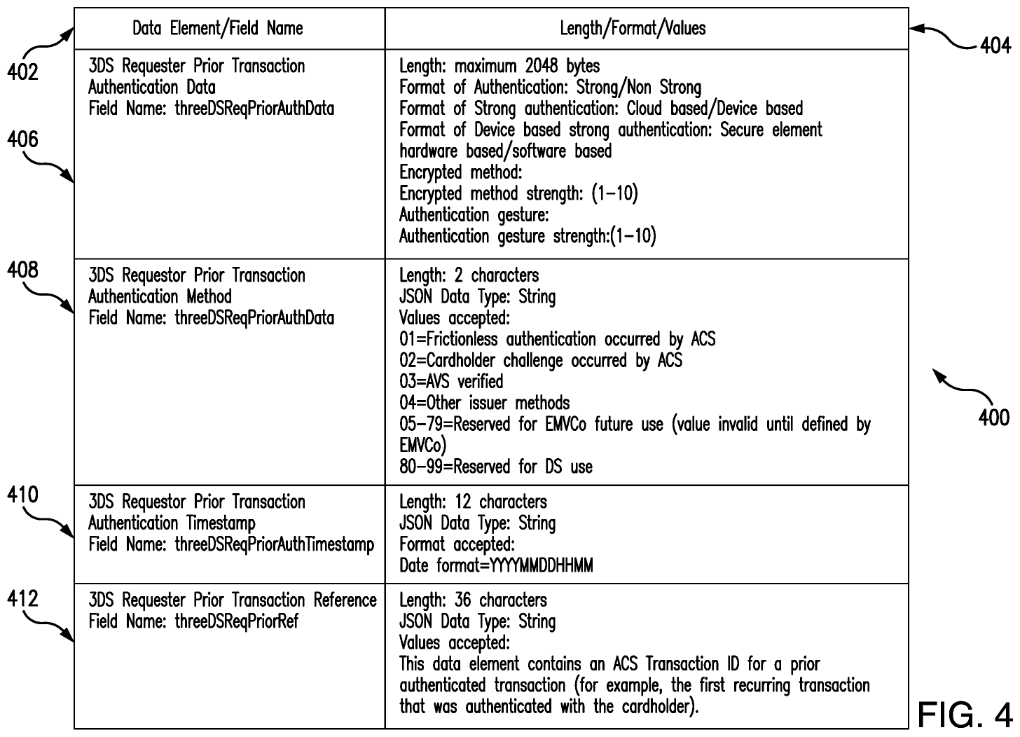

FIG. 4 is a table 400 illustrating data elements and field names for use with the enhanced 3D Secure process according to some embodiments. A Data Element/Field Name column 402 includes the data elements for a 3DS Requestor prior transaction and a field name, whereas a Length/Format/Values column 404 provides associated length, format and method data or information. Thus, row 406 concerns 3DS Requestor Prior Transaction Authentication Data having a Field Name of “threeDSReqPriorAuthData.” This data element indicates if the user authenticated with strong authentication, if the strong authentication was cloud-based or a device-based encrypted method, what the authentication gesture was, the strength of encryption, and the strength of authentication gesture. Thus, in the Length/Forma/Values column 404 for row 406, the 3DS Requestor Prior Transaction Authentication Data may have a Length of a maximum 2048 bytes, a Format of Authentication of “Strong/Non Strong,” a Format of strong authentication of “Cloud based/Device based,” and a Format of Device based strong authentication of “Secure element hardware based/software based.” In addition, data may also indicate the encryption method used, the encrypted method strength (on a scale of 1 (weak) to 10 (strongest), for example), an authentication gesture type, and an authentication strength (which may also be on a scale of from 1 (weak) to 10 (strongest)).

Referring again to FIG. 4, row 408 illustrates a 3DS Requestor Prior Transaction Authentication Method having a Field Name of “threeDSReqPriorAuthMethod,” which describes the mechanism used by the cardholder to authenticate to the 3DS Requestor in a previous transaction. Thus, the Length/Format/Values field in column 404 may include a Length of two characters, a JSON Data Type of “String,” and include the following accepted values:

01=Frictionless authentication occurred by ACS (Access Control Server);

02=Cardholder challenge occurred by ACS;

03=AVS verified

04=Other issuer methods

05-79=Reserved for EMVCo future use (values invalid until defined by EMVCo)

80-99=Reserved for DS use

Row 410 in the table 400 relates to the Data Element of 3DS Requestor Prior Transaction Authentication Timestamp, which has a Field Name of “threeDSReqPriorAuthTimestamp,” and which provides the date and time in the UTC of the prior cardholder authentication. Thus, the Length/Format/Values field in column 404 may include a Length of twelve characters, a JSON Data Type of “String,” and include a date format of year/month/day/hour/minute.

In row 412 of the table 400, the 3DS Requestor Prior Transaction Reference with a Field Name of “threeDSReqPriorRef” is a data element that provides additional information to the ACS to determine the best approach for handling an authentication request. Thus, the Length/Format/Values field in column 404 may include a Length of thirty-six characters, a JSON Data Type of “String,” and include an ACS Transaction ID for a prior authenticated transaction (for example, the first recurring transaction that was authenticated with the cardholder).

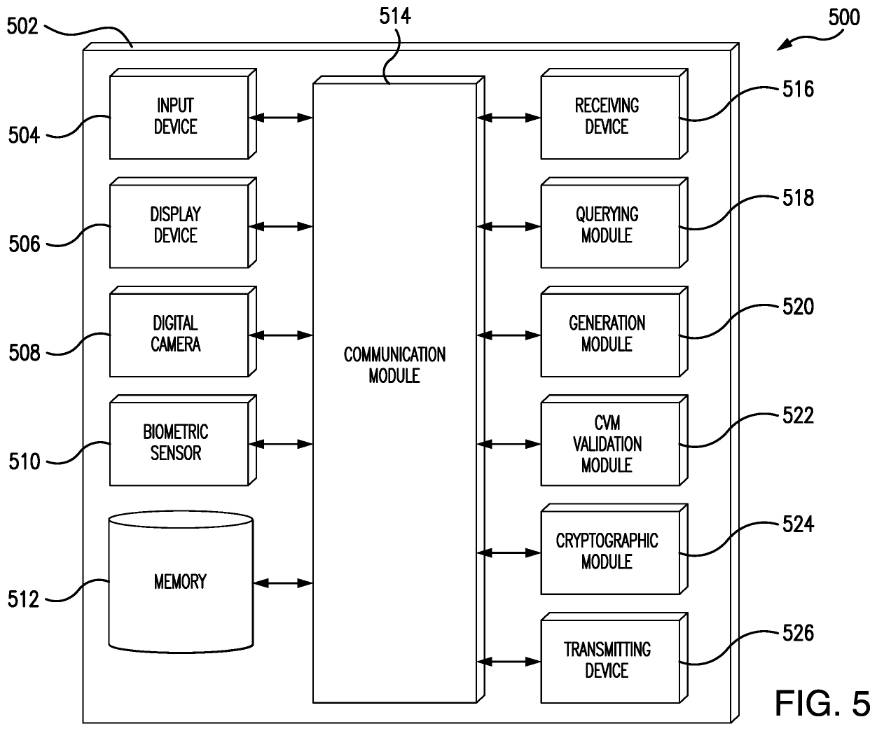

FIG. 5 is a block diagram 500 of a user or consumer mobile device 502 to illustrate device hardware components that may be utilized to perform consumer or user authentication, for example, during purchase transactions in accordance with methods and systems disclosed herein. Currently, many users habitually carry with them mobile devices 502, such as smartphones, tablet computers, wearables or the like, which are configured for entering into mobile payment transactions. The consumer's mobile device 502 (such as an iPhone™ or Android™ device) typically includes hardware components such as a microphone and a speaker (not shown), an input device 504 (which may be a touchscreen), a display device 506, a digital camera 508, and a memory 512. The memory 512 may include any appropriate information storage device, storage component, and/or non-transitory computer-readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

Thus, it should be understood that the term “computer-readable medium” as used herein refers to any non-transitory storage medium that participates in providing data (for example, computer executable instructions or processor executable instructions) that may be read by a computer, a processor, a mobile device processor or controller, or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Various forms of computer readable media may be involved in providing sequences of computer processor-executable instructions to a processor, such as a mobile device processor. For example, sequences of instructions may be delivered from DRAM to a processor,) may be wirelessly transmitted, and/or may be formatted according to numerous formats, standards or protocols, such as Transmission Control Protocol, Internet Protocol (TCP/IP), Wi-Fi, Bluetooth, TDMA, CDMA, and 3G.

Referring again to FIG. 5, some mobile devices 502 also include a biometric sensor, such as a biometric sensor 510 (for example, a fingerprint sensor, an iris sensor, or other type of biometric sensor). The consumer's mobile device 502 also includes a communication module 514 (which may include one or more microprocessors) operably connected to the input device 504, the display device 506, the digital camera 508, the biometric sensor 510, and the memory 512. In addition, in some embodiments the communication module 514 is operably connected to a receiving device 516, a querying module 518, a generation module 520, a CVM validation module 522, a cryptographic module 524 (for any cryptographic operation needed in the device, including encryption and decryption operations, for example, for generating device cryptograms, for securely storing and/or retrieving data in and/or from the memory 512, or for secure communications via the receiving device 516 and transmitting device 526), and a transmitting device 526. In some embodiments, the CVM validation module 522 may contain one or more of a CVM risk management submodule, a transaction credentials management submodule, a wallet CVM management submodule, a consent management submodule, and a cryptogram validity submodule (not shown).

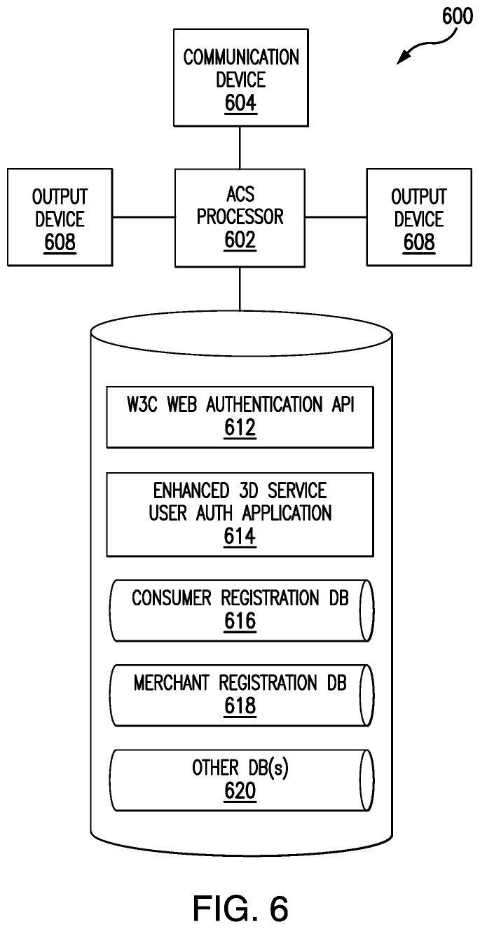

FIG. 6 is a block diagram of an embodiment of an access control server (ACS) computer 600 which may be used in accordance with aspects of the disclosure. The ACS computer 600 may include standard components and/or custom-designed components and/or proprietary components and/or combinations thereof in terms of its hardware and/or its architecture, and may be controlled by software to cause it to function as described herein. For example, the ACS computer 600 may include server computer hardware.

Referring to FIG. 6, the ACS computer 600 may include an ACS processor 602 operatively coupled to a communication device 604, an input device 606, an output device 608, and a storage device 610. The ACS processor 602 may be constituted by one or more processors (one or more of which may be custom designed and/or be of a proprietary design), and operates to execute processor-executable steps, contained in program instructions described below, so as to control the ACS computer 600 to provide desired functionality.

Communication device 604 may be used to facilitate communication with, for example, other devices (such as one or more 3DS server computers, payment network computers, directory server computers, and/or 3DS client devices (for example, one or more consumer mobile devices), and/or one or more computers operated by issuer FIs). For example, communication device 604 may comprise numerous communication ports (not separately shown), to allow the ACS computer 600 to communicate simultaneously with a number of other computers and other devices. Thus, the communication device 604 may be configured for wireless communications and/or wired communications via various different types of networks, such as the Internet.

Input device 606 may comprise one or more of any type of peripheral device typically used to input data into a computer. For example, the input device 606 may include a keyboard and a mouse. Output device 608 may comprise, for example, a display and/or a printer. In some embodiments, the input device 606 and the output device 608 comprise a touch screen.

Storage device 610 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory devices, such as solid state drives (SSDs), and the like. Any one or more of such information storage devices may be considered to be a non-transitory computer-readable storage medium or computer usable medium or memory.

Storage device 610 stores one or more computer programs for controlling the ACS processor 602. The programs comprise program instructions (which may be referred to as computer readable program code means) that contain processor-executable process steps of the ACS computer 600, executed by the ACS processor 602 to cause the ACS computer 600 to operate as disclosed herein. In some implementations, the processor executable instructions, when executed, cause the ACS processor to obtain additional data points and/or analytics related to consumer authentication which occurred during one or more Card-Not-Present (CNP) or online transactions in order to provide an enhanced the 3D Secure 2.0 service, as described herein.

The programs may include one or more conventional operating systems (not shown) that control the ACS 602 to manage and coordinate activities and sharing of resources in the ACS computer 600, and to serve as a host for application programs and/or API's that run on the ACS computer 600. For example, the storage device 610 may store a W3C Web Authentication API 612 that controls the ACS processor 602 to enable the ACS computer 600 to, for example, register a consumer utilizing a consumer device in the enhanced 3D Secure user authentication service. In addition, the storage device 610 may store an enhanced 3D Secure user authentication application 614 which receives user data generated by a Web Authentication API running on the consumer's device in accordance with processes disclosed herein. The storage device 610 may also store, and ACS computer 600 may also execute, other instructions, applications and/or programs, which are not shown. For example, such programs may include a challenge request and response application, which transmits challenge requests to a consumer's device when required to do so. Other programs can also include, e.g., one or more data communication programs, database management programs, device drivers, etc.

The storage device 610 may also store one or more databases, such as a consumer device registration database 616, a merchant registration database 618, and another database 620, one or more of which may be required for operation of the ACS computer 600. For example, the consumer device registration database 616 may include consumer credential information and a user public key, whereas the merchant registration database 618 may include merchant and merchant acquirer bank data, and the like. The other database 620 may include other information and/or data and/or executable instructions which may be necessary for operation of the enhanced 3D Secure service.

The enhanced 3D Secure service process disclosed herein beneficially utilizes standard elements and/or relevant data which captures and/or indicates that a user or consumer has performed strong device-based authentication or universal two-factor authentication (U2FA), resulting in a reduced chance that the user will be stepped-up or required to provide further authentication information. Specifically, the enhanced 3D Secure 2.0 messaging service provides additional data points and/or analytics so that a cardholder is not stepped-up and/or need not perform another user authentication step (such as respond to a challenge message), resulting in an improved user experience and decreasing the likelihood of cart abandonment. In addition to improving the consumer's shopping experience, the disclosed processes can also improve functionality of the scoring engine of the authentication network responsible for authenticating consumers during Card Not Present (CNP) purchase transactions.

Accordingly, the processes disclosed herein solve the technological problem of how to provide an enhanced 3D Secure messaging service that provides additional data in such manner to prevent requiring a user or consumer from having to perform one or more additional authentication steps during the processing of an online transaction. This goal is achieved by providing a process which adds data points and/or analytics in an authentication data package. In disclosed embodiments, such an authentication data package is generated by the user or consumer mobile device by assembling credential information data and assertion data, and then signing the authentication data package before transmission via a Web Authentication API to a Relying Party device. After receiving the signed authentication package, the Relying party device then utilizes the user's public key (which was stored in a memory or database during the consumer registration process) to verify the signature from the consumer's device, discovers the user identification data in a Relying Party (RP) server computer, and transmits the consumer's credential information data and assertion data, via a Relying Party Web client, to a 3DS Server computer for further transaction processing which does not include presenting a challenge message to the user.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An enhanced 3D Secure user authentication process, comprising:
transmitting, by a consumer device processor of a consumer device running a Web Authentication application programming interface (API), a request to a relying party device during a transaction requesting use of an enhanced 3D Secure authentication service;
receiving, by the consumer device processor from the relying party device, a request to authenticate a consumer by using a specific customer verification method (CVM);
prompting, by the consumer device processor running the Web Authentication API, the consumer to provide input in accordance with the CVM;
receiving, by the consumer device processor from an authenticator of the consumer device, input data in accordance with the CVM;
verifying, by the consumer device processor, the consumer based on the input data;
generating, by the consumer device processor running the Web Authentication API, an authentication data package; and
transmitting, by the consumer device processor via the Web Authentication API to the relying party device, the authentication data package for processing and forwarding to a 3D Requestor environment.

2. The method of claim 1, wherein generating the authentication data package comprises assembling, by the consumer device processor, credential information data and assertion data.

3. The method of claim 2, further comprising, prior to transmitting the authentication data package to the relying party device, signing, by the consumer device processor, the authentication data package.

4. The method of claim 3, further comprising:
receiving, by the relying party device, the signed authentication package; and
transmitting, by the relying party device running a relying party Web client to a 3D Server computer of a Requestor environment, the singed authentication package, wherein the signed authentication package is stored for use in future consumer transactions.

5. The method of claim 1, further comprising, prior to transmitting the request to a relying party device requesting use of an enhanced 3D Secure authentication service, registering, by the consumer of the consumer mobile device, to participate in an enhanced 3D Secure service.

6. The method of claim 5, wherein registering for the 3D Secure authentication service comprises:
downloading, by the mobile device processor of the consumer mobile device from a relying party, the Web Authentication API;
generating, by the mobile device processor running the Web Authentication API, a credentials request;
receiving, by the mobile device processor via an authenticator of the consumer mobile device, biometric data of the consumer in response to a credentials request;
generating, by the mobile device processor running the Web Authentication API, a user private key and a user public key; and
transmitting, by the mobile device processor running the Web Authentication API, the user private key and the user public key to the relying party device.

7. The method of claim 6, further comprising:
generating, by the mobile device processor running the Web Authentication API, a credential data package;
signing, by the mobile device processor running the Web Authentication API, the credential data package; and
transmitting, by the mobile device processor to the relying party device, the signed credential data package to complete consumer registration.

8. An enhanced 3D Secure user authentication system comprising:
a consumer mobile device comprising a mobile device processor operably connected to a memory, at least one biometric sensor, and a communication module; and
a relying party device operably connected to the consumer mobile device, wherein the relying party device comprises a processor operably connected to a memory;
wherein the memory of the consumer mobile device includes instructions and a Web Authentication application programming interface (API) which when executed cause the mobile device processor to:
transmit a request to a relying party device during a transaction requesting use of an enhanced 3D Secure authentication service;
receive, from the relying party device, a request to authenticate a consumer by using a specific customer verification method (CVM);
prompt the consumer to provide input in accordance with the CVM;
receive input data in accordance with the CVM from an authenticator of the consumer device;
verify the consumer based on the input data;
generate an authentication data package; and
transmit the authentication data package to the relying party device for processing and forwarding to a 3D Requestor environment.

9. The system of claim 8, wherein the instructions for generating the authentication data package further comprises instructions which when executed cause the mobile device processor to assemble credential information data and assertion data.

10. The system of claim 9, further comprising, prior to the instructions for transmitting the authentication data package to the relying party device, instructions stored in the memory of the consumer mobile device which when executed cause the mobile device processor to sign the authentication data package.

11. The system of claim 10, further comprising a 3D Server computer of a Requestor environment operably connected to the relying party device, and wherein instructions stored in the relying party memory of the relying party device which when executed cause the processor of the relying party device to:
receive the signed authentication package; and
transmit, via a relying party Web client to the 3D Server computer, the signed authentication package, wherein the signed authentication package is stored for use in future consumer transactions.

12. The system of claim 8, further comprising, prior to the instructions for transmitting the request to a relying party device requesting use of an enhanced 3D Secure authentication service, instructions stored in the memory of the consumer mobile device which when executed cause the mobile device processor to register to participate in an enhanced 3D Secure service.

13. The system of claim 12, wherein the instructions for registering for the 3D Secure authentication service comprises instructions stored in the memory of the consumer mobile device which when executed cause the mobile device processor to:
download the Web Authentication API from a relying party;
generate a credentials request;
receive, via an authenticator of the consumer mobile device, biometric data of the consumer in response to a credentials request;
generate a user private key and a user public key; and
transmit the user private key and the user public key to the relying party device.

14. The system of claim 13, further comprising instructions stored in the memory of the consumer mobile device which when executed cause the mobile device processor to:
generate a credential data package;
sign the credential data package; and
transmit the signed credential data package to complete consumer registration.

15. A computer-readable medium storing processor-executable instructions which when executed cause a mobile device processor to:
transmit a request to a relying party device during a transaction to use an enhanced 3D Secure authentication service;
receive a request from the relying party device to authenticate a consumer by using a specific customer verification method (CVM);
prompt the consumer to provide input in accordance with the CVM;
receive, from an authenticator of a consumer device, input data in accordance with the CVM;
verify the consumer based on the input data;
generate an authentication data package; and
transmit the authentication data package to the relying party device to process and forward to a 3D Requestor environment.

16. The computer-readable medium of claim 15, wherein the instructions for generating the authentication data package comprises instructions which when executed cause the mobile device processor to assemble credential information data and assertion data.

17. The computer-readable medium of claim 16, further comprising, prior to the instructions for transmitting the authentication data package to the relying party device, instructions which when executed cause the mobile device processor to sign the authentication data package.

18. The computer-readable medium of claim 17, further comprising, prior to the instructions for transmitting the request to a relying party device requesting use of an enhanced 3D Secure authentication service, instructions which when executed cause the mobile device processor to register to participate in an enhanced 3D Secure service.

19. The computer-readable medium of claim 18, wherein the instructions for registering for the 3D Secure authentication service comprise instructions, which when executed, cause the mobile device processor to:
download a Web Authentication API from a relying party;
generate a credentials request using the Web Authentication API;
receive, via an authenticator of the consumer mobile device, biometric data of the consumer in response to a credentials request;
generate a user private key and a user public key using the Web Authentication API; and
transmit the user private key and the user public key to the relying party device.

20. The computer-readable medium of claim 16 further comprising processor-executable instructions which when executed cause the mobile device processor to:
generate a credential data package using the Web Authentication API;
sign the credential data package using the Web Authentication API; and
transmit the signed credential data package to the relying party device to complete consumer registration.
